(19) United States
(12) Patent Application Publication
(10) Pub. No.: US 2022/0119279 A1
(43) Pub. Date: Apr. 21, 2022

(54) METHOD AND SYSTEM FOR DESALINATING A SALTWATER USING A HUMIDIFIER UNIT

(71) Applicant: Saltworks Technologies, Inc., Richmond (CA)

(72) Inventors: Benjamin Sparrow, Richmond (CA); Henry Tsin, Richmond (CA); Justin Donghoodn Lee, Richmond (CA); Ross Coleman, Richmond (CA)

(21) Appl. No.: 17/425,155

(22) PCT Filed: Jan. 22, 2021
(86) PCT No.: PCT/CA2020/050071

§ 371 Date: Jul. 22, 2021

Related U.S. Application Data
(60) Provisional application No. 62/795,794, filed on Jan. 23, 2019.

(51) Int. Cl. C02F 1/08; C02F 1/04; B01D 3/34; B01D 5/00; B01D 1/00; B01J 19/32

(52) U.S. Cl. CPC C02F 1/08; C02F 1/042; B01D 3/346; C02F 2103/08; B01D 1/0011; B01J 19/32; B01D 5/006

(57) ABSTRACT

Methods, systems, and techniques for desalinating a saltwater using a humidifier unit. The humidifier unit has a housing, which has a carrier gas inlet and a saltwater inlet. The humidifier unit also includes a packing, within the housing, having a surface with a critical surface tension of less than 25 mN/m according to the Zisman method. The packing is arranged to facilitate a saltwater that enters the housing through the saltwater inlet and a carrier gas that enters the housing through the carrier gas inlet to contact each other. The contact facilitates evaporation of the saltwater, which produces salt solids on at least a surface of the packing, a humidified gas and a concentrated brine.

### TECHNICAL FIELD

This present disclosure is directed at systems, processes, and techniques for desalinating a saltwater using a humidifier unit.

### BACKGROUND

Desalination is a process that can concentrate and reduce the volume of a saltwater. Considerable quantities of saltwater, such as flowback and produced water, are generated from oil and gas drilling, completion, and production processes. Flowback and produced water are generally transported to a disposal well for permanent disposal deep underground, which is expensive and causes environmental concerns. Oil and gas companies are looking for ways to treat flowback and produced water close to oil/gas production sites to minimize saltwater transport. Zero Liquid Discharge (ZLD) or Minimum Liquid Discharge (MLD) technologies, which use evaporators and crystallizers to evaporate water and to produce salt solids, have been applied to eliminate or minimize saltwater deep well disposal.

### SUMMARY

According to a first aspect, there is provided a system for desalinating a saltwater, the system comprising: a heater configured to receive and heat the saltwater; and a humidifier unit, comprising: a housing comprising a carrier gas inlet fluidly coupled to a carrier gas source and a saltwater inlet fluidly coupled to the heater; and a packing within the housing, wherein a surface of the packing has a critical surface tension of less than 25 mN/m according to the Zisman method and the packing is arranged to facilitate the saltwater that enters the housing through the saltwater inlet and the carrier gas that enters the housing through the carrier gas inlet to contact each other. The critical surface tension may in particular be less than 20 mN/m according to the Zisman method.

The housing may further comprise a humidified gas outlet for discharging a humidified gas and a concentrated salt outlet for discharging concentrated brine and salt solids.

The system may further comprise a solids management unit fluidly coupled to the concentrated salt outlet and configured to separate at least some of the salt solids from the concentrated brine.

The system may further comprise a dehumidifier unit fluidly coupled to the humidified gas outlet and configured to condense water vapor from the humidified gas to produce a condensate.

The packing may have a specific surface area of between 10 to 60 m²/m³. In particular, the packing may have a specific surface area of between 15 to 50 m²/m³, or between 20-40 m²/m³.

The packing may have a void fraction of at least 90%. In particular, the void fraction may be at least 92%, or at least 94%.

The packing may comprise a non-random arrangement of packing pieces.

The non-random arrangement may comprise a repeating pattern.

The packing surface may comprise at least one of fluoropolymer and silicone.

The fluoropolymer may be selected from a group consisting of ethylene-tetrafluoroethylene copolymer, fluorinated ethylene-propylene, perfluoroalkoxy polymer, and polytetrafluoroethylene.

According to another aspect, there is provided a process for desalinating a saltwater, the process comprising: heating the saltwater; directing the heated saltwater and a carrier gas to a packing within the humidifier unit, wherein a surface of the packing has a critical surface tension of less than 25 mN/m according to the Zisman method; evaporating, in the humidifier unit, at least some water comprising part of the saltwater into the carrier gas to produce: salt solids on at least the surface of the packing; a humidified gas; and a concentrated brine having a salt concentration higher than the saltwater. The critical surface tension may in particular be less than 20 mN/m according to the Zisman method.

The process may further comprise cleaning at least some of the salt solids off the surface of the packing by flowing at least one of the saltwater and the concentrated brine over the surface of the packing.

The cleaning may be performed without removing the packing from the humidifier unit.

The cleaning may occur during the evaporating.

The process may further comprise directing the concentrated brine and the salt solids to a solids management unit, and separating at least some of the salt solids from the concentrated brine using the solids management unit.

The process may further comprise directing the humidified gas to a dehumidifier unit and using the dehumidifier unit to condense at least some water from the humidified gas to produce a condensate and an at least partially dehumidified gas.

The process may further comprise recycling at least some of the at least partially dehumidified gas as the carrier gas input to the humidifier unit.

The packing may have a specific surface area of between 10 to 60 m²/m³. In particular, the packing may have a specific surface area of between 15 to 50 m²/m³, or between 20-40 m²/m³.

The packing may have a void fraction of at least 90%. In particular, the void fraction may be at least 92%, or at least 94%.

The packing may comprise a non-random arrangement of packing pieces.

The non-random arrangement may comprise a repeating pattern.

The surface of the packing may comprise at least one of fluoropolymer and silicone.

The fluoropolymer may be selected from a group consisting of ethylene-tetrafluoroethylene copolymer, fluorinated ethylene-propylene, perfluoroalkoxy polymer, and polytetrafluoroethylene.

According to another aspect, there is provided a humidifier unit, comprising: a housing comprising a carrier gas inlet and a saltwater inlet; and a packing within the housing, wherein a surface of the packing has a critical surface tension of less than 25 mN/m according to the Zisman method and the packing is arranged to facilitate a saltwater that enters the housing through the saltwater inlet and a carrier gas that enters the housing through the carrier gas inlet to contact each other. The critical surface tension may in particular be less than 20 mN/m according to the Zisman method.

The housing may further comprise a humidified gas outlet for discharging a humidified gas and a concentrated salt outlet for discharging concentrated brine and salt solids.

The packing may have a specific surface area of between 10 to 60 m²/m³. In particular, the packing may have a specific surface area of between 15 to 50 m²/m³, or between 20-40 m²/m³.

The packing may have a void fraction of at least 90%. In particular, the void fraction may be at least 92%, or at least 94%.

The packing may comprise a non-random arrangement of packing pieces.

The non-random arrangement may comprise a repeating pattern.

The surface of the packing may comprise at least one of fluoropolymer and silicone.

The fluoropolymer may be selected from a group consisting of ethylene-tetrafluoroethylene copolymer, fluorinated ethylene-propylene, perfluoroalkoxy polymer, and polytetrafluoroethylene.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 is a schematic diagram illustrating a prior art humidifier unit comprising a traditional packing.

FIGS. 2A-2C illustrate prior art packing used in the humidifier unit of FIG. 1 with no salt solids deposited thereon (FIG. 2A), and top plan (FIG. 2B) and side elevation (FIG. 2C) views of the packing with a high amount of salt solids deposited thereon.

FIG. 3A is a schematic diagram illustrating an example embodiment of a humidifier unit, and FIG. 3B is a perspective view depicting packing used in the example humidifier unit of FIG. 3A.

FIG. 4 is a perspective view of a portion of the packing of FIG. 3B after the humidifier unit of FIG. 3A has been used for desalination.

FIG. 5 is a schematic diagram illustrating an example embodiment of a humidification-dehumidification desalination system comprising the humidifier unit shown in FIG. 3A.

For the sake of clarity, not every component is labeled, nor is every component of each embodiment shown where illustration is unnecessary to allow those of ordinary skill in the art to understand the embodiments described herein.

### DETAILED DESCRIPTION

Thermal-energy based desalination technologies, such as multiple effect distillation (MED), multistage flashing (MSF) distillation, and humidification-dehumidification (HDH) desalination, are often used to concentrate and reduce the volume of a saltwater when ZLD or MLD treatment is required. An HDH desalination system, which comprises a humidifier unit as an evaporator and a dehumidifier unit as a condenser and which uses a carrier gas (e.g., air) to evaporate a saltwater, permits water evaporation at an ambient pressure and without a high temperature (e.g., >100° C.) steam line. This can be advantageous when compared to the MED and MSF distillation systems.

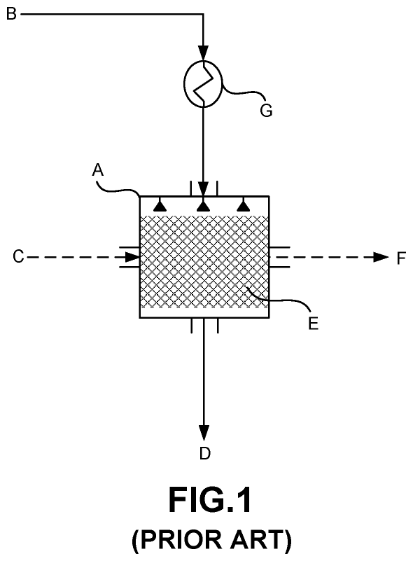

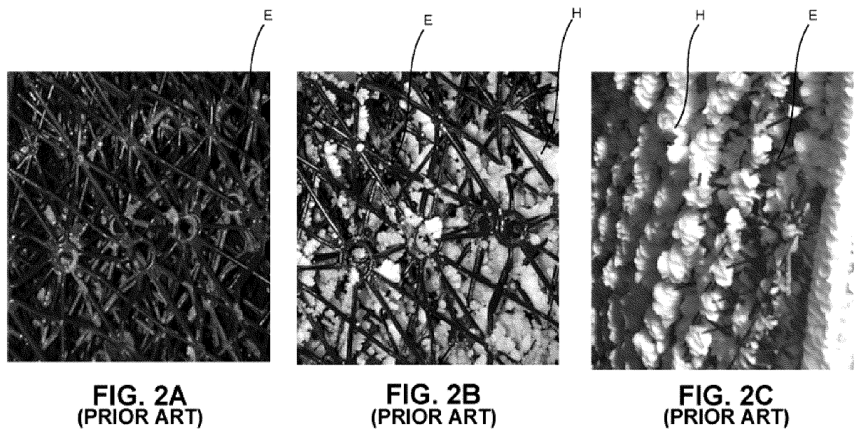

FIG. 1 shows a conventional (prior art) humidifier unit A that may be used in an HDH desalination system to at least partially evaporate a saltwater B, thereby forming a concentrated brine D having a salt concentration higher than that of the saltwater B. The brine D may be of any suitable salt concentration, such as a concentration above that of the saltwater B and below a salt saturation concentration so that salt does not precipitate out of the brine D. The humidifier unit A comprises a packing E, as discussed in more detail below in respect of FIGS. 2A-2C. When the humidifier unit A is used to evaporate the saltwater B, the saltwater B is first heated by a heater Gin fluid communication with the humidifier unit A. The heated saltwater B is fed together with a dry air C into the humidifier unit B. The heated saltwater B comes in direct contact with the air C in the humidifier unit A, and a portion of water is evaporated from the saltwater B into the air C. As a result, the air C becomes humidified and exits as humidified air F, and the saltwater becomes the brine D.

The efficiency of saltwater evaporation in the humidifier unit A increases with an increase in saltwater-air contact area. The packing E helps to enlarge the saltwater-air contact area. The packing E typically has a large specific surface area (e.g., more than 100 m²/m³). As used in this disclosure, “a specific surface area” of a packing refers to the total surface area of the packing per unit volume of space occupied. The saltwater-air contact area is also determined by the wettability of the surface of the packing E (“packing surface”) toward the saltwater B. Conventionally, it is generally believed that a packing with high surface wettability for saltwater is beneficial for enlarging the saltwater-air contact area and increasing evaporation efficiency. While falling through the packing E with high surface wettability, the saltwater B spreads out as a thin film over the packing surface. The thin film of the saltwater B enlarges the saltwater-air contact area and facilitates evaporation of the saltwater B into the air C.

The surface wettability of a material can be evaluated by the material's critical surface tension: a high critical surface tension corresponds to a high energy surface and high wettability for saltwater. The critical surface tension is generally measured according to the Zisman method. Table 1 below lists the critical surface tensions for various materials (adapted from Kinloch, A. J. Adhesion and Adhesives Science and Technology, Chapman and Hall, New York, 1987).

TABLE 1
Critical Surface Tensions of Various Materials

| Material | Critical Surface Tension (mN/m) |
|---|---|
| Glass | about 1000 |
| Poly(vinyl chloride) | 39.0 |
| Polyethylene | 31.0 |
| Polypropylene | 31.0 |
| Poly(vinylidene fluoride) | 25.0 |
| Silicone | 24.0 |
| Polytetrafluoroethylene | 18.5 |
| Polyhexafluoropropylene | 16.2-17.1 |

The packing E in the prior art humidifier unit A shown in FIG. 1 is made from plastic polymers, such as polyethylene, polypropylene and polyvinyl chloride, with a critical surface tension above 30 mN/m and with good surface wettability for the saltwater B. The prior art humidifier unit A can be used to evaporate the saltwater B, thereby reducing its volume to a certain degree.

As the saltwater B evaporates, its salt concentration increases. It has been experimentally found that when the prior art humidifier unit A is used to evaporate the saltwater B such that the salt concentration exceeds the saltwater's B salt saturation concentration, salt solids are produced inside the humidifier unit A; more particularly, in at least some cases massive amounts of salt solids are deposited onto the packing surface. FIG. 2A shows an example packing E with no salt solids H deposited thereon, while FIGS. 2B and 2C respectively show top plan and side elevation views of the packing E with a high amount of salt solids H deposited thereon. In FIGS. 2A-2C, the packing E is a polypropylene net packing (around 80 m²/m³ in specific surface area) and the saltwater B comprises about 20 wt % sodium chloride. FIG. 2A shows a clean surface of the polypropylene net packing E before the saltwater B reaches the sodium chloride saturation concentration and consequently before the salt solids H are produced and deposited onto the packing E. Further evaporation of the saltwater B once it is saturated with sodium chloride results in massive amounts of salt solids H being deposited onto the polypropylene net packing E. This is visible in FIGS. 2B and 2C, in which the salt solids H occupy almost all the void volume and clog both air and saltwater flow channels inside the packing E. The evaporation capacity of the prior art humidifier unit A gradually decreases with increasing salt solids H deposition. Eventually, the salt solids H block the packing's E flow channels completely and operation of the prior art humidifier unit A has to be paused so that the packing E can be removed from the humidifier unit A and replaced. The packing E with the salt solids H deposited thereon is cleaned outside of the humidifier unit A with fresh water. Disrupted operation represented by the removal, replacement, and cleaning of the packing E comes at the cost of treatment capacity and consequently increases operating costs of a conventional HDH desalination system.

Without being limited to a specific theory, depositing massive amounts of salt solids H onto the packing surface is caused by the formation of a thin film of the saltwater B on the packing surface. When the packing surface has high surface wettability for the saltwater B, the packing surface provides a large substrate for heterogeneous nucleation of salt crystallization. After the saltwater B is evaporated to a concentration above the salt saturation concentration, salt crystals form a solid film attached to the packing surface. The salt crystal film then serves as seeding sites promoting more deposition of the salt solids H as the saltwater's B evaporation continues. As a result, salt solids grow from the packing surface and fill the voids in the packing E, clogging air and saltwater flow channels in the packing E.

In contrast to the prior art humidifier unit A, in at least some embodiments herein there is described a humidifier unit that may be used to evaporate saltwater and that comprises a packing that has a low surface energy (e.g., a critical surface tension of the packing surface material of less than 25 mN/m) and a concordant low surface wettability for saltwater. As described further below, in at least some embodiments the humidifier unit is used to evaporate a saltwater and to produce salt solids inside the humidifier without blocking air and/or saltwater flow channels inside the packing to the same degree as the prior art humidifier unit A.

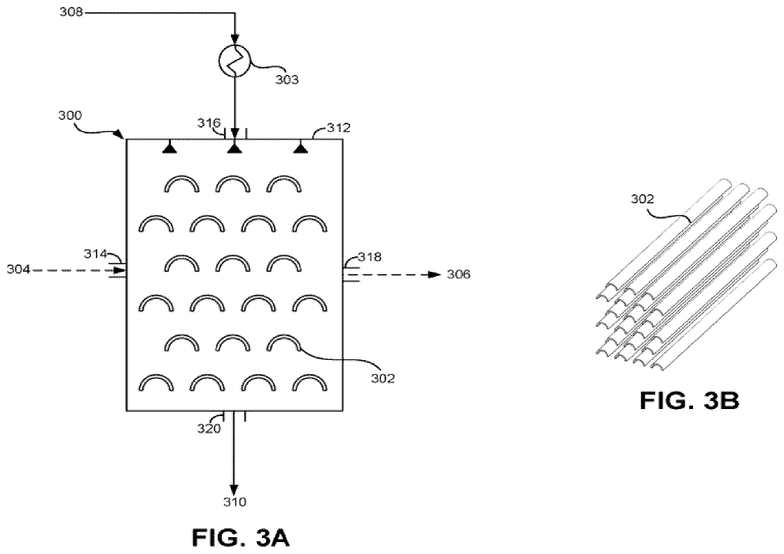

Turning now to FIG. 3, there is shown schematically an embodiment of a humidifier unit 300, according to one embodiment. The humidifier unit 300 may be used in an HDH desalination system to evaporate a saltwater 308 to a concentration above a salt saturation concentration, thereby producing a concentrated brine and salt solids 310, and to subsequently discharge the brine and salt solids 310 from the humidifier unit 300. The humidifier unit 300 comprises a housing 312 having a carrier gas inlet 314 for receiving a carrier gas 304 such as air, a saltwater inlet 316 for receiving the saltwater 308 to be desalinated, a humidified gas outlet 318 to discharge a humidified gas 306 that results from desalination, and a concentrated salt outlet 320 to discharge a concentrated salt in the form of concentrated brine and/or salt solids that also result from desalination. Desalination may be performed by the humidifier unit 300 alone, as the humidified gas 306 comprising water vapor from evaporating saltwater 308 is discharged directly into the atmosphere of the humidifier unit 300; additionally, and as discussed further below, a dehumidifier unit may also be used in the desalination process to produce fresh water from that water vapor. A first heater 303 is fluidly coupled to the saltwater inlet 316 to heat the saltwater 308 prior to desalination. In FIG. 3A, the concentrated salt outlet 320 is positioned at the bottom of the humidifier unit 300 so that saltwater droplets fall to it, as discussed further below. The humidifier unit 300 also comprises a packing 302 made from a material having a surface with low surface energy and accordingly a low surface wettability for the saltwater 308. In at least some embodiments, the surface of the packing 302 comprises a material with a critical surface tension according to the Zisman method of less than 25 mN/m, and in at least some embodiments less than 20 mN/m. When falling through the packing 302 in the humidifier unit 300, the saltwater 308 lands onto the surface of the packing 302 and, because of the packing's 302 low wettability, the saltwater 308 does not spread out as a thin film onto the packing surface. Instead, the saltwater 308 forms saltwater droplets on the packing surface, which quickly roll off the packing surface in view of the packing surface's low wettability.

According to at least some embodiments, the surface material of the packing 302 in the humidifier unit 300 comprises at least one of fluoropolymer and silicone. The packing 302 may be made directly from at least one of fluoropolymer and silicone. Alternatively, the packing 302 may be made from a material with a coated or lined surface of at least one of fluoropolymer and silicone. The fluoropolymer may be selected from a group of ethylene-tetrafluoroethylene copolymer, fluorinated ethylene-propylene, perfluoroalkoxy polymer, and polytetrafluoroethylene.

According to at least some embodiments, the packing 302 in the humidifier unit 300 comprises a smaller specific surface area and wider channels compared to the traditional packing E of polyethylene, polypropylene, and polyvinyl chloride that may be used in the prior art humidifier unit A. As used herein, the “void volume” of the packing 302 is the empty space within the packing 302 reachable by both the saltwater 308 and the carrier gas 304 (e.g., the wider channels referred to above). The packing 302 in the humidifier unit 300 has a specific surface area of 10-60 m²/m³, in at least some embodiments 15-50 m²/m³, and in at least some additional embodiments 20-40 m²/m³. Additionally or alternatively, the packing 302 in the humidifier unit 300 has a void fraction of at least 90%, in at least some embodiments at least 92%, and in at least some additional embodiments at least 94%. As used in this disclosure, “a void fraction” of the packing 302 refers to the fraction of the void volume in the packing 302 over the total volume of the packing 302.

It has been experimentally found that in at least some embodiments in which the humidifier unit 300 comprises a perfluoroalkoxy polymer-based or polytetrafluoroethylene-based structured packing 302 with a specific surface area more than 80 m²/m³, channels in the packing 302 can become partially clogged by salt solids. However, the extent of the clogging was less than that depicted in the prior art of FIGS. 2B and 2C, and the salt solids can be cleaned using a clean-in-place process without taking the packing 302 out of the humidifier unit 300. In at least some embodiments in which the humidifier unit 300 comprises a polytetrafluoroethylene packing 302 with a specific surface area of 30 m²/m³, the channels remained open during the evaporation process.

According to at least some embodiments, the packing 302 in the humidifier unit 300 comprises individual packing pieces arranged in an organized (i.e., non-random) pattern. A random packing comprises individual packing pieces arranged randomly, thereby forming tortuous channels between those pieces; an example way of creating a random packing is to pour individual packing pieces into an otherwise empty housing 312. The channels in the packing 302 of the humidifier unit 300 are in at least some embodiments not as tortuous as those seen in a packing comprising a heap of randomly arranged packing pieces. It has been experimentally found that while a humidifier unit with a random packing of polytetrafluoroethylene packing pieces had improved performance compared to the traditional polypropylene packing, as measured by there being fewer salt solids deposited onto the surface of those pieces, tortuous channels in the random packing prevented salt solids from falling through the packing and consequently inhibited operational efficiency over time. Therefore, the packing in the humidifier unit 300 is in at least some embodiments not random. More particularly, the individual pieces comprising the packing 302 may be discrete or connected, but assembled in an organized pattern to provide open channels such that salt solids are allowed to fall together with the saltwater and/or the concentrated brine through the packing 302 and to the concentrated salt outlet 320. In at least some embodiments, the packing 302 comprises pieces that form a repeating pattern throughout the humidifier unit 300. For example, as depicted in FIG. 3A and as discussed further in respect of FIG. 3B below, the packing 302 may comprise a repeating pattern of layered packing pieces.

FIG. 3B shows a perspective view of the packing pieces comprising the packing 302 of the humidifier unit 300 of FIG. 3A. The packing pieces are polytetrafluoroethylene bars. The bars have a convex side that face away from the concentrated salt outlet 320, thereby facilitating dripping of saltwater 308 and/or brine off the bars and towards the outlet 320. The polytetrafluoroethylene bars are assembled in an organized pattern with first spaces between respective bars in the horizontal direction and second spaces between respective bars in the vertical direction. Each of the first spaces in FIGS. 3A and 3B has a size equal to a first value, and each of the second spaces in FIGS. 3A and 3B has a size equal to a second value that is different from the first value. In at least some different embodiments, however, the sizes of the first and second spaces may or may not be equal. The spaces between the bars form channels for the carrier gas 304 (e.g., air), the saltwater 308, the humidified gas 306, and the concentrated brine and salt solids 310 to move through the packing 302. In at least some different embodiments (not shown), the packing 302 may comprise in an organized pattern any one or more of films, wires, rods, tubes, and trays, which are made from at least one of fluoropolymer and silicone or from a material with a coated surface that comprises at least one of fluoropolymer and silicone.

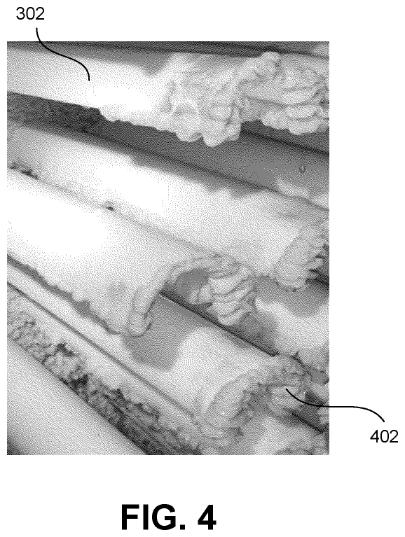

FIG. 4 is a perspective view of a portion of the packing 302 of FIG. 3B after the humidifier unit 300 has been used for desalination. In FIG. 4, the convex surfaces of the packing 302 are generally clean, and there remain open channels through the packing 302 even after use. In FIG. 4, the packing 302 comprises packing pieces in the form of polytetrafluoroethylene bars arranged in an organized-pattern (around 30 m²/m³ in specific surface area). The saltwater 308 that is evaporated comprises about 20 wt % sodium chloride, and is evaporated to a concentration above the saltwater's 308 sodium chloride saturation concentration, thereby producing the concentrated brine and salt solids 310 in the form of a sodium chloride saturated brine and sodium chloride solids 402 inside the humidifier unit 300. Compared to FIGS. 2B and 2C, a fairly low amount of salt solids 402 are deposited onto the edges of individual packing bars, and the packing surface is almost clean. Channels in the packing 302 accordingly do not become clogged as a result of the humidifier unit's 300 operation.

Without being limited to a specific theory, as the packing surface in the humidifier unit 300 has low surface wettability for the saltwater 308, instead of forming thin films on the packing surface while the humidifier unit 300 is in use, the saltwater 308 forms saltwater droplets on the packing surface. Most of the saltwater droplets roll off the packing surface quickly and into open channels in the packing 302. The saltwater droplets at least partially evaporate when in direct contact with the carrier gas 304 inside the humidifier unit 300. As a result, the humidified gas 306 and the concentrated brine and salt solids 310 are produced. Salt solids are formed inside open channels and on the packing surface. At least some of the salt solids 402 that form on the packing surface are cleaned off the packing surface into open channels by the falling saltwater 308 and/or concentrated brine. The cleaning takes place while the humidifier unit 300 is in use; i.e., during evaporation of the saltwater 308 and without having to remove the packing 302 from the humidifier unit 300. As channels in the packing 302 of the humidifier unit 300 are relatively open (the void fraction is above 90%), the concentrated brine and salt solids 310 exit from the humidifier unit 300 through the concentrated salt outlet 320.

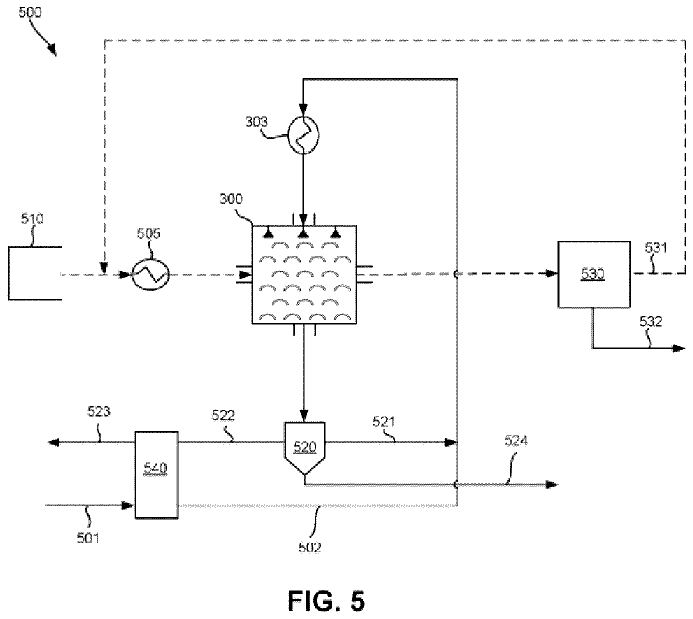

FIG. 5 illustrates, according to one example embodiment, an HDH desalination system 500 to evaporate the saltwater 308 and to produce salt solids. The system 500 comprises the humidifier unit 300 as described in detail above in respect of FIG. 3A. The system 500 further comprises the first heater 303, which receives and heats the saltwater 308, and a carrier gas source 510, which provides the carrier gas 304 to the humidifier unit 300. The humidifier unit 300 is fluidly coupled to the carrier gas source 510 and the first heater 303 to receive the carrier gas 304 and the heated saltwater 308, respectively. The humidifier unit 300 facilitates evaporation of at least some of the saltwater 308 into the carrier gas 304, thereby producing the humidified gas 306 and the concentrated brine and salt solids 310. The concentrated brine has a salt concentration higher than the saltwater 308, and the salt solids 402 are deposited on the surface of the packing 302. As discussed above, at least some of the salt solids 402 may be cleaned off the packing 302 by falling saltwater and/or brine generated during desalination.

In at least some embodiments, the system 500 further comprises a second heater 505 fluidly coupled to the carrier gas source 510 and to the humidifier unit 300 to heat the carrier gas 306 before the carrier gas 306 enters the humidifier unit 300, a solids management unit 520 fluidly coupled to the humidifier unit 300 to receive the concentrated brine and salt solids 310 and to separate at least of a portion of the salt solids from the concentrated brine, and a dehumidifier unit 530 fluidly coupled to the humidifier unit 300 to receive the humidified gas 306 and to condense at least some water vapor from the humidified gas 306 to form condensate, and a heat exchanger 540 fluidly coupled to the solids management unit 520 to receive blowdown brine and to transfer heat from the blowdown brine to the saltwater 308 entering the system 500.

In at least some embodiments, the system 500 may comprise several humidification units 300 and/or several dehumidification units 530 arranged in series or parallel (not shown in FIG. 5).

In at least some embodiments, a process of using the system 500 to desalinating a saltwater comprises:
(i) heating the saltwater 308;
(ii) directing the heated saltwater 308 and the carrier gas 304 to the packing 302 within the humidifier unit 300, wherein a surface of the packing has a critical surface tension according to the Zisman method of less than 25 mN/m;
(iii) evaporating, in the humidifier unit 300, at least some water comprising part of the saltwater 308 into the carrier gas 304 to produce:
   (1) the salt solids 402 on at least a surface of the packing 302;
   (2) the humidified gas 306; and
   (3) a concentrated brine having a salt concentration higher than the saltwater 308; and
(iv) cleaning at least some of the salt solids 402 off the surface of the packing 302 by flowing the saltwater 308 and/or the concentrated brine over the surface of the packing 302.

As a result of the evaporating, the salt solids 402 are formed on at least a surface of the packing 302. In at least some example embodiments, the salt solids 402 are additionally formed in the void volume of the packing 302 and/or the inner surface of the housing 312.

In operation, the saltwater 308 can originate from a variety of sources; for example, seawater, brackish water, an oil and/or gas well, or an industrial process (e.g., the effluent of a wastewater treatment process). The saltwater 308 may have dissolved salts in relatively high amounts (e.g., a total dissolved solid content of more than 200,000 mg/L). The saltwater 308 is directed via conduit 501 into the system 500.

In at least some embodiments, the saltwater 308 may be preheated by flowing it through a heat exchanger 540 to recover some residual heat of a blowdown brine. In at least some other embodiments (not shown in FIG. 5), the saltwater 308 may be preheated by flowing it through the dehumidifier unit 530 to recover at least some of the heat of condensation by dehumidifying the humidified gas 306 using the dehumidifier unit 530.

After entering the system 500 through conduit 501, the saltwater 308 is directed via conduit 502 to the first heater 303, which heats the saltwater 308 (e.g., to a temperature between 30-100° C.). The heated saltwater 308 is then directed into the humidifier unit 300. At the same time, the carrier gas 304 from the carrier gas source 510 is also directed into the humidifier unit 300. The carrier gas 304 may be heated by the second heater 505 before entering the humidifier unit 300. In the embodiment shown in FIG. 5, the saltwater 308 and the carrier gas 304 are directed in accordance with a crossflow method into the humidifier unit 300. In at least some other embodiments (not shown), the saltwater 308 and the carrier gas 304 may be directed in accordance with a countercurrent flow method into the humidifier unit 300.

The heated saltwater 308 falls from the saltwater inlet 316 and through the packing 302 in the humidifier unit 300, and forms saltwater droplets when it impacts the packing surface. The saltwater droplets at least partially evaporate when in direct contact with the carrier gas 304 in the packing's 302 channels. As a result of the saltwater's 308 evaporation, the carrier gas 304 becomes humidified, the saltwater 308 becomes a concentrated brine, and salt solids 402 are produced inside the packing channels and on the packing surface. At least some of the salt solids 402 on the packing surface are cleaned off the packing surface and fall into the packing channels by virtue of coming into contact with the falling saltwater 308 and/or concentrated brine. This cleaning of the packing 302 takes place during saltwater evaporation and without removing the packing 302 from the humidifier unit 300.

The concentrated brine and salt solids 310 exiting the humidifier unit 300 are directed to the solids management unit 520. In at least some embodiments, the solids management unit 530 comprises one or more of a solids filtration unit, a solids clarification unit, and a hydrocyclone. The solids management unit 520 separates at least some of the salt solids from the concentrated brine. The separated salt solids are discharged via conduit 524 out of the system 500. The concentrated brine may be recirculated via recirculation conduit 521, and then through the first heater 303 and the humidifier unit 300 for further evaporation. At least some of the concentrated brine may be blown down via conduits 522 and 523 out of the system 500. In at least some embodiments, the residual heat in the blowdown brine is recovered by flowing the blowdown brine through the heat exchanger 540. The heat exchanger 540 transfers heat from the blowdown brine to the saltwater 308 entering the system 500. In at least some other embodiments, the solids management unit 520 comprises a crystallizer. The concentrated brine is cooled in the crystallizer to a temperature (e.g., around 0° C.) to further crystallize salt solids from the concentrated brine.

The humidified gas 306 exiting the humidifier unit 300 is substantially saturated with water vapor (e.g., more than 90% relative humidity). In at least some embodiments (not shown), the humidified gas 306 exiting the humidifier unit 300 is discharged out of the system 500 and directly into the atmosphere. In at least some other embodiments, the humidified gas 306 exiting the humidifier unit 300 is directed to the dehumidifier unit 530. At least some water vapor in the humidified gas 306 is condensed in dehumidifier unit 530. The vapor condensation produces a condensate and an at least partially dehumidified gas. The condensate is discharged via conduit 532 out of the system 500. In at least some embodiments, at least some of the at least partially dehumidified gas is recycled via conduit 531 back to the humidifier unit 300 and is reused as the carrier gas 304 for saltwater evaporation.

The system 500 shown in FIG. 5 is operated in a continuous manner; however, in at least some other embodiments (not depicted), the system 500 may be operated in a batch manner or a semi-batch manner by controlling suitable valves, conduits, tanks and pumps (not shown in FIG. 5).

As used herein, two components are “in fluid communication” or are “fluidly coupled” to each other when they are directly or indirectly connected such that a fluid in the form of a gas and/or liquid can be transferred between them. Two components being in fluid communication or fluidly coupled to each other does not prevent them from also transferring solids between each other. Additionally, the term “and/or” when used in conjunction with multiple items means any one or more of those items. For example, “A, B and/or C” means “any one or more of A, B, and C”.

It is contemplated that any part of any aspect or embodiment discussed in this specification can be implemented or combined with any part of any other aspect or embodiment discussed in this specification.

One or more example embodiments have been described by way of illustration only. This description is presented for purposes of illustration and description but is not intended to be exhaustive or limited to the form disclosed. It will be apparent to persons skilled in the art that a number of variations and modifications can be made without departing from the scope of the claims.

1. A system for desalinating a saltwater, the system comprising:
(a) a heater configured to receive and heat the saltwater; and
(b) a humidifier unit, comprising:
(i) a housing comprising a carrier gas inlet fluidly coupled to a carrier gas source and a saltwater inlet fluidly coupled to the heater; and
(ii) a packing within the housing, wherein a surface of the packing has a critical surface tension of less than 25 mN/m according to the Zisman method and the packing is arranged to facilitate the saltwater that enters the housing through the saltwater inlet and the carrier gas that enters the housing through the carrier gas inlet to contact each other.

2. The system of claim 1, wherein the housing further comprises a humidified gas outlet for discharging a humidified gas and a concentrated salt outlet for discharging concentrated brine and salt solids.

3. The system of claim 2, further comprising a solids management unit fluidly coupled to the concentrated salt outlet and configured to separate at least some of the salt solids from the concentrated brine.

4. The system of claim 2, further comprising a dehumidifier unit fluidly coupled to the humidified gas outlet and configured to condense water vapor from the humidified gas to produce a condensate.

5. The system of claim 1, wherein the packing has a specific surface area of between 10 to 60 m²/m³.

6. The system of claim 5, wherein the packing has a void fraction of at least 90%.

7. The system of claim 5, wherein the packing comprises a non-random arrangement of packing pieces.

8. The system of claim 7, wherein the non-random arrangement comprises a repeating pattern.

9. The system of claim 5, wherein the packing surface comprises at least one of fluoropolymer and silicone.

10. The system of claim 9, wherein the fluoropolymer is selected from a group consisting of ethylene-tetrafluoroethylene copolymer, fluorinated ethylene-propylene, perfluoroalkoxy polymer, and polytetrafluoroethylene.

11. A process for desalinating a saltwater, the process comprising:
(a) heating the saltwater;
(b) directing the heated saltwater and a carrier gas to a packing within the humidifier unit, wherein a surface of the packing has a critical surface tension of less than 25 mN/m according to the Zisman method; and
(c) evaporating, in the humidifier unit, at least some water comprising part of the saltwater into the carrier gas to produce:
(i) salt solids on at least the surface of the packing;
(ii) a humidified gas; and
(iii) a concentrated brine having a salt concentration higher than the saltwater.

12. The process of claim 11, further comprising cleaning at least some of the salt solids off the surface of the packing by flowing at least one of the saltwater and the concentrated brine over the surface of the packing.

13. The process of claim 12, wherein the cleaning is performed without removing the packing from the humidifier unit.

14. The process of claim 12, wherein the cleaning occurs during the evaporating.

15. The process of claim 11, further comprising directing the concentrated brine and the salt solids to a solids management unit, and separating at least some of the salt solids from the concentrated brine using the solids management unit.

16. The process of claim 11, further comprising directing the humidified gas to a dehumidifier unit and using the dehumidifier unit to condense at least some water from the humidified gas to produce a condensate and an at least partially dehumidified gas.

17. The process of claim 16, further comprising recycling at least some of the at least partially dehumidified gas as the carrier gas input to the humidifier unit.

18. The process of claim 11, wherein the packing has a specific surface area of between 10 to 60 m²/m³.

19. The process of claim 18, wherein the packing has a void fraction of at least 90%.

20. The process of claim 11, wherein the packing comprises a non-random arrangement of packing pieces.

21. The process of claim 20, wherein the non-random arrangement comprises a repeating pattern.

22. The process of claim 11, wherein the surface of the packing comprises at least one of fluoropolymer and silicone.

23. The process of claim 22, wherein the fluoropolymer is selected from a group consisting of ethylene-tetrafluoroethylene copolymer, fluorinated ethylene-propylene, perfluoroalkoxy polymer, and polytetrafluoroethylene.
